(19) United States
(12) Patent Application Publication
(10) Pub. No.: US 2023/0115279 A1
(43) Pub. Date: Apr. 13, 2023

(54) FUEL CELL SYSTEM AND CONTROL METHOD THEREOF

(71) Applicant: Toshiba Energy Systems & Solutions Corporation, Kawasaki-shi Kanagawa (JP)

(72) Inventor: Sayaka AKIYAMA, Chigasaki Kanagawa (JP)

(73) Assignee: Toshiba Energy Systems & Solutions Corporation, Kawasaki-shi Kanagawa (JP)

(21) Appl. No.: 17/821,580

(22) Filed: Aug. 23, 2022

(30) Foreign Application Priority Data
Sep. 24, 2021 (JP) 2021-155993

(51) Int. Cl. H01M 8/04858; H01M 8/04992; H01M 8/04955

(52) U.S. Cl. CPC H01M 8/0494; H01M 8/04955; H01M 8/04992

(57) ABSTRACT

A fuel cell system includes a plurality of fuel cells and a control device that controls an operation state of each fuel cell. The control device has a command receiver that acquires an output command showing a total output power which should be generated by the fuel cell system, a first determiner that determines the number of fuel cells which should be operated in the normal operation mode, and an operation state manager that determines the operation state of each fuel cell. Based on the output command, the operation state manager changes the operation state of at least one of the fuel cells which are being operated in the normal operation mode to the standby operation mode, or changes the operation state of at least one of the fuel cells which are being operated in the standby operation mode to the normal operation mode.

### CROSS-REFERENCE TO RELATED APPLICATIONS

This application is based upon and claims the benefit of priority from Japanese Patent Application No. 2021-155993, filed Sep. 24, 2021; the entire contents of which are incorporated herein by reference.

### FIELD OF THE INVENTION

Embodiments of the present invention relate to a fuel cell system and a control method thereof.

### BACKGROUND ART

A fuel cell system is known as a system that directly converts chemical energy of a fuel gas into electricity. A fuel cell system comprises a fuel cell that generates electricity by electrochemically reacting hydrogen, which is a fuel, and oxygen, which is an oxidant. Such a fuel cell system can extract electric energy with high power generation efficiency. JP2001-102074A discloses a fuel cell system comprising a plurality of fuel cells.

It is desired to improve responsiveness of output power of a fuel cell system to a required output power.

### BRIEF DESCRIPTION OF THE DRAWINGS

FIG. 1 is a block diagram showing a structure of a fuel cell system according to a first embodiment.

FIG. 2 is a view showing a structure of a fuel cell included in the fuel cell system shown in FIG. 1.

FIG. 3 is a view showing a structure of the control device of the fuel cell system shown in FIG. 1.

FIG. 4 is a flowchart showing a control method of the fuel cell system according to the first embodiment.

FIG. 5 is a flowchart showing the control method of the fuel cell system according to the first embodiment.

FIG. 6 is a view showing a structure of a control device of a fuel cell system according to a second embodiment.

FIG. 7 is a flowchart showing a control method of the fuel cell system according to the second embodiment.

FIG. 8 is a flowchart showing the control method of the fuel cell system according to the second embodiment.

### DETAILED DESCRIPTION OF THE INVENTION

A fuel cell system according to an embodiment comprises:
a plurality of fuel cells; and a control device that controls an operation state of each fuel cell;
wherein:
each fuel cell is capable of being operated in multiple operation modes including a normal operation mode in which the fuel cell is operated to output power with a power generation efficiency equal to or greater than a first power generation efficiency, and a standby operation mode in which the fuel cell is operated to output power with a power generation efficiency equal to or less than a second power generation efficiency which is lower than the first power generation efficiency;
the control device has:
a command receiver that acquires an output command showing a total output power which should be generated by the fuel cell system;
a first determiner that determines the number of fuel cells which should be operated in the normal operation mode, based on the total output power shown by the output command; and
an operation state manager that determines the operation state of each fuel cell, based on the number of fuel cells determined by the first determiner;
when the total output power shown by the output command is lower than a total output power which is being generated by the fuel cell system, or when the number of fuel cells determined by the first determiner is less than the number of fuel cells which are being operated in the normal operation mode, the operation state manager changes the operation state of at least one of the fuel cells which are being operated in the normal operation mode to the standby operation mode; and
when the total output power shown by the output command is greater than a total output power which is being generated by the fuel cell system, or when the number of fuel cells determined by the first determiner is greater than the number of fuel cells which are being operated in the normal operation mode, the operation state manager changes the operation state of at least one of the fuel cells which are being operated in the standby operation mode to the normal operation mode.

A control method according to an embodiment is a control method of a fuel cell system including a plurality of fuel cells each of which is capable of being operated in multiple operation modes including a normal operation mode in which the fuel cell is operated to output power with a high power generation efficiency equal to or greater than a first power generation efficiency, and a standby operation mode in which the fuel cell is operated to output power with a low power generation efficiency equal to or less than a second power generation efficiency which is lower than the first power generation efficiency, the control method comprising:
a step of acquiring output command that acquires an output command showing a total output power which should be generated by the fuel cell system;
a step of determining the number of normal-mode fuel cells that determines the number of fuel cells which should be operated in the normal operation mode, based on the total output power shown by the output command; and
a step of determining operation state that determines an operation state of each fuel cell, based on the number of fuel cells determined in the step of determining the number of normal-mode fuel cells;
wherein:
in the step of determining operation state, when the total output power shown by the output command is lower than a total output power which is being generated by the fuel cell system, or when the number of fuel cells determined in the step of determining the number of normal-mode fuel cells is less than the number of fuel cells which are being operated in the normal operation mode, the operation state of at least one of the fuel cells which are being operated in the normal operation mode is changed to the standby operation mode; and
in the step of determining operation state, when the total output power shown by the output command is greater than a total output power which is being generated by the fuel cell system, or when the number of fuel cells determined in the step of determining the number of normal-mode fuel cells is greater than the number of fuel cells which are being operated in the normal operation mode, the operation state of at least one of the fuel cells which are being operated in the standby operation mode is changed to the normal operation mode.

### First Embodiment

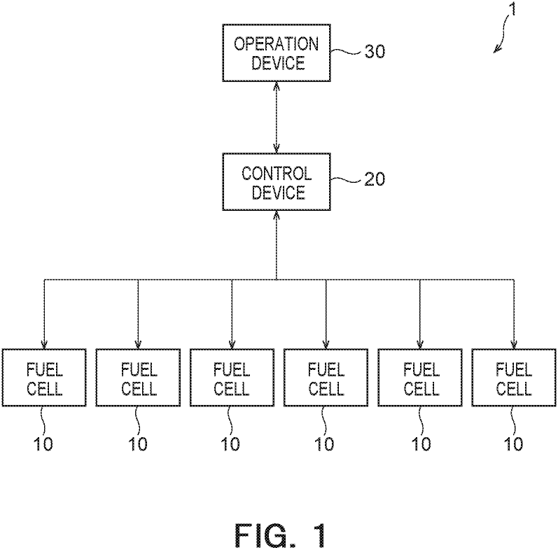

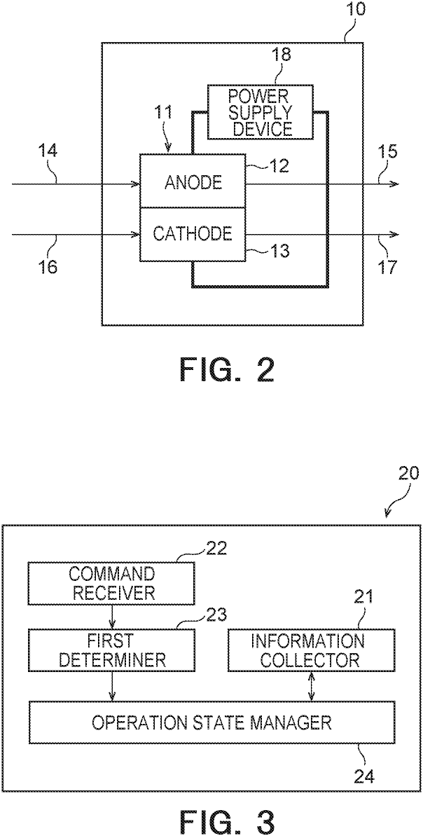

A first embodiment is described hereunder with reference to the drawings. FIG. 1 is a block diagram showing a structure of a fuel cell system 1 according to a first embodiment. FIG. 2 is a view for schematically describing a structure of a fuel cell 10 included in the fuel cell system 1 shown in FIG. 1.

The fuel cell system 1 comprises a plurality of the fuel cells 10, a control device 20, and an operating device 30.

The fuel cell 10 generates electricity using hydrogen and oxygen. Each fuel cell 10 may be a polymer electrolyte fuel cell (PEFC), for example. In the example shown in FIG. 2, the fuel cell 10 has a fuel cell stack 11, a fuel supply pipe 14, a fuel discharge pipe 15, an air supply pipe 16, an air discharge pipe 17, and a power supply device 18.

The fuel cell stack 11 comprises an anode 12 and a cathode 13 between which an electrolyte membrane is sandwiched. The fuel supply pipe 14 is connected to an inlet of the anode 12. Through the fuel supply pipe 14, a hydrogen gas is supplied to the anode 12. The fuel discharge pipe 15 is connected to an outlet of the anode 12. Through the fuel discharge pipe 15, a gas from the anode 12 is discharged to the outside or inside of the fuel cell 10. The air supply pipe 16 is connected to an inlet of the cathode 13. Through the air supply pipe 16, an oxygen gas in the air is supplied to the cathode 13. The air discharge pipe 17 is connected to an outlet of the cathode 13. Through the air discharge pipe 17, a gas from the cathode 13 is discharged to the outside of the fuel cell 10.

The fuel cell stack 11 generates electricity using the hydrogen gas, which is supplied to the anode 12 through the fuel supply pipe 14, and the oxygen gas in the air, which is supplied to the cathode 13 through the air supply pipe 16.

The power supply device 18 is connected to an electrode of the fuel cell stack 11. The power supply device 18 extracts an electric current from the fuel cell stack 11. In the illustrated example, the maximum output power of each fuel cell 10 is 100 kW.

The control device 20 controls an operation state of each fuel cell 10. Specifically, the control device 20 transmits a control signal to each fuel cell 10 to operate each fuel cell 10 in multiple operation modes including a normal operation mode and a standby operation mode. Also, the control device 20 transmits a control signal to each fuel cell 10 to deactivate or activate the fuel cell 10. Namely, each fuel cell 10 receives a control signal from the control device 20 to be operated in any one of the following operation states: the normal operation mode, the standby operation mode, and the inactive state.

When operated in the normal operation mode, the fuel cell 10 outputs power with a power generation efficiency equal to or greater than a first power generation efficiency, which allows the fuel system 1 as a whole to achieves the power generation efficiency equal to or greater than a predetermined power generation efficiency. When operated in the standby operation mode, the fuel cell 10 outputs power with a power generation efficiency equal to or less than a second power generation efficiency which is lower than the aforementioned first power generation efficiency. In the illustrated example, when operated in the standby operation mode, the fuel cell 10 is electrically disconnected from the system to which the fuel cell system 1 supplies power, and this fuel cell 10 is operated autonomously.

In the illustrated example, when operated in the normal operation mode, the fuel cell 10 outputs power which is 40% to 60%, or which is 42% to 58%, of the maximum output power of this fuel cell. In the illustrated example, when operated in the normal operation mode, the fuel cell 10 outputs power with the maximum power generation efficiency of this fuel cell. In general, when the fuel cell 10 is operated to output power which is about 50% of the maximum output power of this fuel cell 10, its power generation efficiency is maximum. In the illustrated example, when operated in the normal operation mode, each fuel cell 10 outputs power which is 50% of its maximum output power. As described above, since the maximum output power of each fuel cell 10 is 100 kW in the illustrated example, the output power of the fuel cell 10 operated in the normal operation mode is 50 kW.

Furthermore, in the illustrated example, when operated in the standby operation mode, the fuel cell 10 outputs power which is 5% to 15% of the maximum output power of this fuel cell 10. In the illustrated example, when operated in the standby operation mode, the fuel cell 10 outputs power which is 10% of the maximum output power of this fuel cell 10. As described above, since the maximum power output of each fuel cell 10 is 100 kW in the illustrated example, the output power of the fuel cell 10 operated in the standby operation mode is 10 kW.

Hereunder, a fuel cell 10 operated in the normal operation mode is referred to also as “normal-mode fuel cell” or “normal-mode FC”. In addition, hereunder, a fuel cell 10 operated in the standby operation mode is referred to also as “standby-mode fuel cell” or “standby-mode FC”, and a fuel cell 10 in the non-active state is referred to also as “inactive fuel cell” or “inactive FC” hereunder. Furthermore, hereunder, output power of a fuel cell 10 operated in the normal operation mode is referred to also as “normal output power”, and output power of a fuel cell 10 operated in the standby operation mode is referred to also as “standby output power”.

FIG. 3 is a block diagram schematically showing the structure of the control device 20. As shown in FIG. 3, the control device 20 has an information collector 21, a command receiver 22, a first determiner 23, and an operation state manager 24.

The information collector 21 acquires the following information: the number of normal-mode fuel cells 10, the number of standby-mode fuel cells 10, and the number of times each fuel cell 10 has been activated. In the illustrated example, the information collector 21 obtains the above information (i.e. the number of normal-mode fuel cells 10, the number of standby-mode fuel cells 10, and the number of times each fuel cell 10 has been activated) from the operation state manager 24.

The command receiver 22 acquires an output command showing total output power which should be generated by the fuel cell system 1. In the illustrated example, the command receiver 22 acquires the aforementioned total output power from the operation device 30. Hereunder, total output power shown by an output command is referred to also as “commanded total output power”. Furthermore, total output power which is being outputted by the fuel cell system 1 is referred to also as “current total output power”.

When receiving commanded total output power which differs from the current total output power, the first determiner 23 determines, based on the output command (or the commanded total output power), the number of fuel cells 10 which should be operated in the normal operation mode, and inputs the number of fuel cells 10 determined by itself to the operation state manager 24. The first determiner 23 determines the number of fuel cells 10 which should be operated in the normal operation mode, based on the result obtained by dividing the commanded total output power by the normal output power. For example, when the commanded total output power is 200 kW and the normal output power is 50 kW, the result obtained by dividing the commanded total output power by the normal output power is 200 kW/50 kW=4. Thus, the first determiner 23 determines that the number of fuel cells 10 which should be operated in the normal operation mode is 4. When the commanded total output power is equal to the current total output power, there is no input from the first determiner 23 to the operation state manager 24. Hereunder, the number of fuel cells 10 which should be operated in the normal operation mode, which is determined by the first determiner 23, is referred to also as “the commanded number of normal-mode fuel cells”.

The operation state manager 24 determines the operation state of each fuel cell 10 based on the commanded number of normal-mode fuel cells, which is determined by the first determiner 23. When the commanded total output power is lower than the current total output power (i.e., when the commanded number of normal-mode fuel cells is less than the number of normal-mode fuel cells), the operation state manager 24 changes the operation state of at least one of the normal-mode fuel cells 10 to the standby operation mode. On the other hand, when the commanded total output power is greater than the current total output power (i.e., when the commanded number of normal-mode fuel cells is greater than the number of normal-mode fuel cells), the operation state manager 24 changes the operation state of at least one of the standby-mode fuel cells 10 to the normal operation mode, or changes the operation state of at least one of the inactive fuel cells 10 to the normal operation mode.

For example, suppose that the normal output power is 50 kW, that the number of normal-mode fuel cells is five, and that the current total output power is 250 kW. Under this state, an output command showing that the commanded total output power is 200 kW is inputted, the first determiner 23 determines that the commanded number of normal-mode fuel cells is four. In this case, the operation state determiner 24 changes the operation mode of one of the five normal-mode fuel cells 10 to the standby operation mode.

Alternatively, for example, suppose that the normal output power is 50 kW, that the number of the normal-mode fuel cells is three, and that the current total output power is 150 kW. Under this state, an output command showing that the commanded total output power is 200 kW is inputted, the first determiner 23 determines that the commanded number of normal-mode fuel cells is four. In this case, the operation state manager 24 selects, from the plurality of fuel cells 10, a fuel cell 10 which is not operated in the normal operation mode, and changes the operation state of the selected fuel cell 10 to the normal operation mode.

If there are multiple normal-mode fuel cells 10 when the operation state manager 24 changes the operation state of a normal-mode fuel cell 10 to the standby operation mode, the operation state 24 selects the fuel cell 10 whose operation state is to be changed to the standby operation mode in the following manner. Namely, the operation state manager 24 selects, from the normal-mode fuel cells 10, a fuel cell 10 which has been activated the least number of times among the normal-mode fuel cells 10 based on the information acquired by the information collector 21, as a fuel cell 10 whose operation state is to be changed to the standby operation mode.

If there are multiple inactive fuel cells 10 when the operation state manager 24 changes the operation state of a inactive fuel cell 10 to the normal operation mode, the operation state determiner 24 selects a fuel cell 10 whose operation state is to be changed to the normal operation mode in the following manner. Namely, the operation state determiner 24 selects, from the inactive fuel cells 10, a fuel cell 10 which has been activated the least number of times among the inactive fuel cells 10 based on the information acquired by the information collector 21, as a fuel cell whose operation state is to be changed to the normal operation mode.

When the number of standby-mode fuel cells 10, which is obtained by the information collector 21, is greater than a predetermined number N, the operation state manager 24 selects, from the standby-mode fuel cells 10, a fuel cell 10 which has been activated the least number of times among the standby-mode fuel cells 10 based on information acquired by the information collector 21, as a fuel cell 10 which is to be deactivated.

As described above, in the fuel cell system 1 according to the first embodiment, when the number of the normal-mode fuel cells 10 is greater than the number of fuel cells 10 which are required to be in normal operation mode in order to output the commanded total output power, the operation state of a normal-mode fuel cell 10 which is surplus to the requirement is changed to the standby operation mode, instead of being immediately changed to the inactive state. Alternatively, in the fuel cell system 1 according to the first embodiment, when the number of the normal-mode fuel cells 10 is less than the number of fuel cells 10 which are required to output the commanded total output power, the number of fuel cells 10 operated in the normal operation mode is increased in such a manner that, when the fuel cell system 1 includes a standby-mode fuel cell 10 and a inactive fuel cell 10, the operation state of the standby-mode fuel cell 10 is changed to the normal operation mode, in priority to the inactive fuel cell 10. By controlling the plurality of fuel cells 10 in such a manner as described above, it is possible to reduce occasion of activating a inactive fuel cell 10, when the total output power of the fuel cell system 1 is increased. As a result, responsiveness of output power of the fuel cell system 1 can be improved.

In addition, in the fuel cell system 1 according to the first embodiment, the fuel cell 10 which has been activated/deactivated the least number of times among the normal-mode fuel cells 10 is selected as a fuel cell 10 whose operation state is to be changed from the normal operation mode to the standby operation mode. Further, in the fuel cell system 1 according to the first embodiment, the fuel cell 10 which has been activated/deactivated the least number of times among the standby-mode fuel cells 10 is selected as a fuel cell 10 whose operation state is to be changed from the standby operation mode to the inactive state. By changing the operation state of the fuel cell 10 which has been activated/deactivated the least number of times from the normal operation mode to the standby operation mode, or from the standby operation mode to the deactivated state, it is possible to hinder the plurality of fuel cells 10 from being activated/deactivated unevenly. In other words, by doing so, it is possible to reduce a risk that certain fuel cells 10 among the plurality of fuel cells 10 are activated/deactivated more frequently than the other fuel cells and the number of activation/deactivation of the certain fuel cells 10 increases rapidly as compared with the other fuel cells 10. Thus, it is possible to hinder the certain fuel cells 10 among the plurality of fuel cells 10 from degrading quickly as compared with the other fuel cells 10. As a result, the fuel cell system 1 can be reliably operated.

In the fuel cell system 1 according to the first embodiment, the fuel cell 10 which has been activated/deactivated the least number of times among the inactive fuel cells 10 is selected as a fuel cell 10 whose operation state is to be changed from the inactive state to the standby operation mode. This can also hinder the plurality of fuel cells 10 from being activated/deactivated unevenly, and can hinder the certain fuel cells 10 among the plurality of fuel cells 10 from degrading quickly as compared with the other fuel cells 10.

As described above, when the commanded total output power is equal to the current total output power, there is no input from the first determiner 23 to the operation state manager 24. Thus, in this case, the operation state manager 24 does not change the operation state of any fuel cells 10. In other words, in this case, the operation state of the normal-mode fuel cell 10 is maintained to be the normal operation mode, the operation state of the standby-mode fuel cell 10 is maintained to be the standby operation mode, and the operation state of the inactive fuel cell 10 is maintained to be the inactive state.

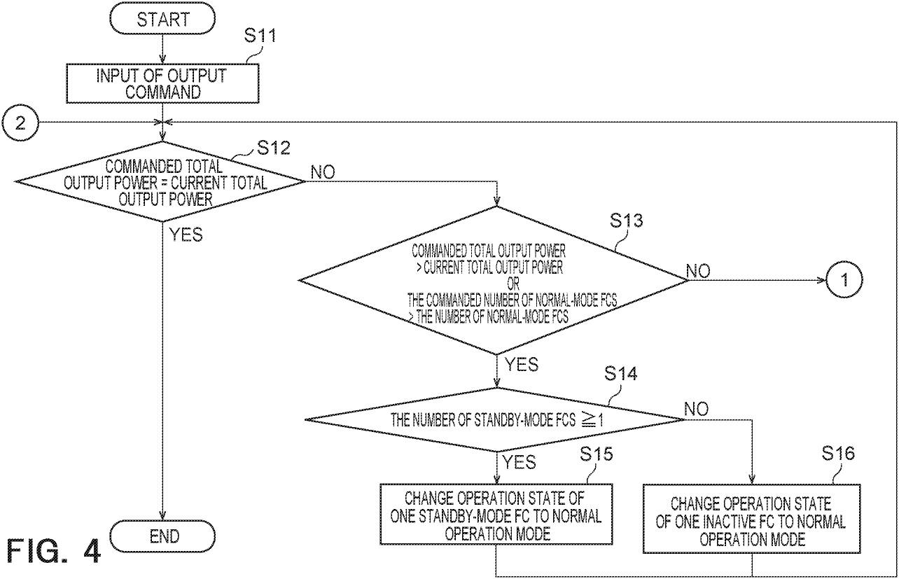

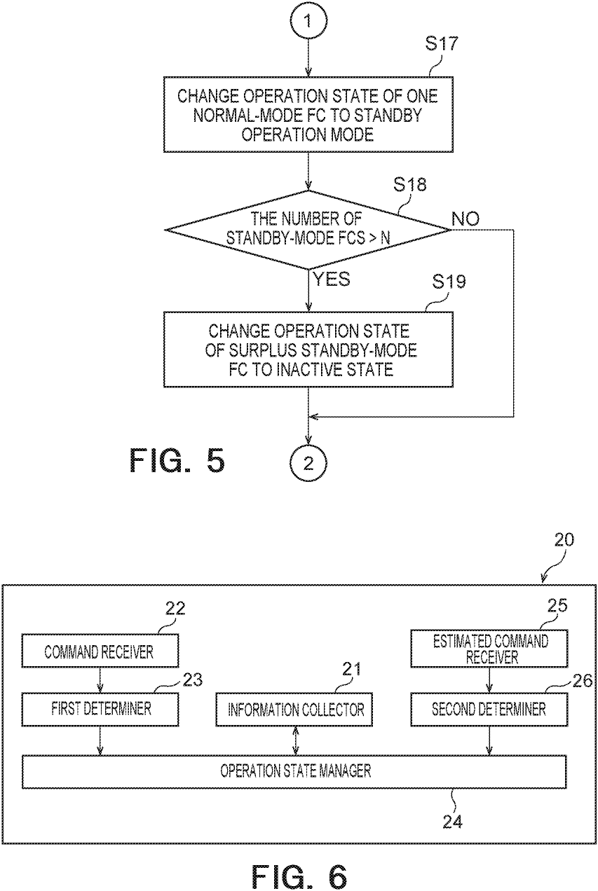

Next, a control method of the fuel cell system 1 is described with reference to FIGS. 4 and 5. Herein, description is made on the assumption that the number of fuel cells 10 included in the fuel cell system 1 is six, that the maximum output power of each fuel cell 10 is 100 kW, that the normal output power of each fuel cell 10 is 50 kW, and that commanded total output power will be any of 0 kW, 50 kW, 100 kW, 150 kW, 200 kW, 250 kW and 300 kW.

As shown in FIG. 4, the command receiver 22 acquires, from the operation device 30, an output command showing total output power which should be generated by the fuel cell system 1 (i.e., commanded total output power) (step S11).

Then, the first determiner 23 judges whether the commanded total output power is equal to the current total output power (step S12). When the commanded total output power is equal to the current total output power (YES in step S12), the operation state of each fuel cell 10 is maintained.

Meanwhile, in step S12, when the commanded total output power is different from the current total output power (NO in step S12), the first determiner 23 judges whether the commanded total output power is greater than the current total output power (step S13). In step S13, the first determiner 23 may judge whether the value which is obtained by dividing the commanded total output power by the normal output power (i.e., the commanded number of normal-mode fuel cells) is greater than the number of normal-mode fuel cells 10. When the commanded total output power is greater than the current total output power (or the commanded number of normal-mode fuel cells is greater than the number of normal-mode fuel cells 10) (YES in step S13), the first determiner 23 transmits the commanded number of normal-mode fuel cells to the operation state manager 24. The operation state manager 24 acquires the number of standby-mode fuel cells 10 from the information collector 21, and judges whether the number of standby-mode fuel cells 10 is no less than one (step S14). When the number of standby-mode fuel cells 10 is greater than or equal to one (YES in step S14), the operation state manager 24 changes the operation state of one of the standby-mode fuel cells 10 to the normal operation mode (step S15). As a result, this fuel cell 10 is operated in the normal operation mode. After that, the judgment of step S12 is performed again. In step S15, the operation state manager 24 transmits, to the information collector 21, information about the operation state of each fuel cell 10.

In step S14, when there is no standby-mode fuel cell 10 (NO in step S14), the operation state manager 24 selects, from the inactive fuel cells 10, one fuel cell which has been activated/deactivated the least number of times among the inactive fuel cells 10, and changes the operation state of the selected fuel cell to the normal operation mode (step S16). As a result, this selected fuel cell 10 is activated and is operated in the normal operation mode. After that, the judgment of step S12 is performed again.

Next, a case in step S13 in which the commanded total output power is less than the current total output power (or the commanded number of normal-mode fuel cells is less than the number of normal-mode fuel cells 10) (NO in step S13) is described. In this case, the first determiner 23 transmits the commanded number of normal-mode fuel cells to the operation state manager 24. Then, the operation state manager 24 acquires, from the information collector 21, information about the number of times each fuel cell 10 has been activated/deactivated, selects one fuel cell which has been activated/deactivated the least number of times among the normal-mode fuel cells 10, and changes the operation state of the selected fuel cell to the standby operation mode (step S17). As a result, this selected fuel cell 10 is operated in the standby operation mode. Thereafter, the operation state manager 24 judges whether the number of standby-mode fuel cells 10 is greater than the predetermined number N (step S18). In step S18, when the number of standby-more fuel cells 10 is judged to be greater than the predetermined number N (YES in step S18), the operation state manager 24 selects at least one standby-mode fuel cell 10 which has been activated/deactivated the least number of times among the standby-mode fuel cells 10, and deactivates the selected fuel cell 10 (step S19). In this step, the number of fuel cells 10 whose operation state is to be changed from the standby operation mode to the inactive state is equal to the value obtained by subtracting the predetermined number N from the number of the standby-mode fuel cells 10. This value shows the number of surplus standby-mode fuel cells 10. Due to step S19, the same number of standby-mode fuel cells 10, which have been activated/deactivated the least number of times, as the aforementioned surplus standby-mode fuel cells 10 are deactivated. In step S19, the operation state manager 24 transmits, to the information collector 21, information about the operation state of each fuel cell 10. After that, the judgment of step S12 is performed again.

Meanwhile, in step S18, when the number of standby-mode fuel cells 10 is judged to be less than the predetermined number N (NO in step S18), the operation state manager 24 does not change the operation state of any standby-mode fuel cells 10. The operation state manager 24 transmits, to the information collector 21, information about the operation state of each fuel cell 10. After that, the judgment of step S12 is performed again.

In the aforementioned one embodiment, when there is no standby-mode fuel cell 10 in step S14 (NO in step S14), a inactive fuel cell 10 is activated. However, the disclosure is not limited thereto. In the case of NO in step S14, when the plurality of fuel cells 10 includes fuel cells 10 whose operation state is shifting from the standby operation mode (or normal operation mode) to the inactive state, the operation state manager 24 may change the operation state of one of these fuel cells (i.e., the fuel cells whose operation state is shifting to the deactivated state) to the normal operation mode. This can hinder increase in the number of activation/deactivation of the above fuel cell.

### Second Embodiment

Next, a fuel cell system 1 according to a second embodiment is described with reference to FIGS. 6 to 8. The fuel cell system 1 in the second embodiment shown in FIG. 6 differs from the fuel cell system according to the first embodiment in that the control device 20 includes an estimated command receiver 25 and a second determiner 26. The other structure of the fuel cell system 1 according to the second embodiment is substantially the same as that of the fuel cell system 1 according to the first embodiment shown in FIGS. 1 to 5. In the second embodiment shown in FIGS. 6 to 8, the same parts as in the first embodiment shown in FIGS. 1 to 5 have the same reference numerals, and detailed description thereof is omitted.

The estimated command receiver 25 acquires an estimated output command showing a total output power which is estimated to be generated by the fuel cell system 1 in the future. In the illustrated example, the estimated command receiver 25 acquires an estimated output command from the operation device 30. An estimated output command, which shows a total output power which is estimated to be generated by the fuel cell system 1 between 20 minutes and 40 minutes later, is inputted from the operation device 30 to the estimated command receiver 25 every 20 minutes. Hereunder, the total output power shown by the estimated output command is referred to also as “estimated total output power”.

Upon receipt of input of the estimated output command, the second determiner 26 calculates the number of fuel cells 10 which are required to output the estimated total output power. Specifically, the second determiner 26 calculates the number of fuel cells 10 which are required to output the estimated total output power, by dividing the estimated total output power by the normal output power. Then, the second determiner 26 compares the calculation result with the sum of the number of normal-mode fuel cells 10 and the number of standby-mode fuel cells 10 at the present time (i.e., at the time point when the estimated output command is inputted). When the calculation result is greater than the aforementioned sum, the second determiner 26 inputs, to the operation state manager 24, the difference between the calculation result and the aforementioned sum, as the number of fuel cells 10 whose operation state is expected to be changed from the inactive state to the standby operation mode. On the other hand, when the calculation result is equal to or less than the aforementioned sum, there is no input from the second determiner 26 to the operation state manager 24.

Hereunder, the number of fuel cells 10 which are required to output the estimated total output power is referred to also as “the estimated number of necessary fuel cells”. In addition, the sum of the number of normal-mode fuel cells 10 and the number of standby-mode fuel cells 10 at the present time (i.e., at the time point when the estimated output command is inputted) is referred to also as “the number of currently operated fuel cells”. The difference between the estimated number of necessary fuel cells and the number of currently operated fuel cells is referred to also as “the number of insufficient fuel cells”.

Upon receipt of input of the number of insufficient fuel cells M from the second determiner 26, the operation state manager 24 changes the operation state of inactive fuel cells 10 to the standby operation mode. In this case, the operation state manager 24 selects the same number of inactive fuel cells 10, which have been activated/deactivated the least number of times among the inactive fuel cells 10, as the number of insufficient fuel cells M calculated by the second determiner 26, and changes the operation state of the selected fuel cells 10 to the standby operation mode. As a result, the same number of inactive fuel cells 10 as the number of insufficient fuel cells M are activated and operated in the standby operation mode. Thus, the fuel cells 10 which are sufficient for outputting the estimated total output power are operated in the normal operation mode or the standby operation mode.

When the commanded number of normal-mode fuel cells is inputted from the first determiner 23, the operation state manager 24 calculates the difference between the commanded number of normal-mode fuel cells and the number of normal-mode fuel cells as the shortage of normal-mode fuel cells for outputting the estimated total output power. This is the number of fuel cells 10 whose operation state is to be changed from the standby operation mode to the normal operation mode. Then, the operation state manager 24 selects the same number of standby-mode fuel cells 10 as the calculation result, and changes the operation state of the selected standby-mode fuel cells 10 to the normal operation mode. Hereunder, the number of fuel cells 10 whose operation state is to be changed from the standby operation mode to the normal operation mode upon receipt of the input of the commanded number of normal-mode fuel cells is referred to also as “the number of insufficient normal-mode fuel cells”.

As described above, in the fuel cell system 1 according to the second embodiment, an estimated output command is inputted on a regular basis. When the estimated number of necessary fuel cells is greater than the number of currently operated fuel cells, one or more inactive fuel cells are activated to be operated in the standby operation mode. Thus, when the commanded total output power increases so that the number of fuel cells 10 which should be operated in the normal operation mode increases, it is only sufficient to change the operation state of some standby-mode fuel cells 10 to the normal operation mode, and is not necessary to activate inactive fuel cells 10. As a result, responsiveness of an output power of the fuel cell system 1 can be improved. In addition, when the operation state of some inactive fuel cells 10 is changed to the standby operation mode, since the fuel cells 10 which have been activated/deactivated the least number of times among the inactive fuel cells 10 are selected to be activated, it is possible to hinder the fuel cells 10 from being activated/deactivated unevenly. As a result, it is possible to hinder certain fuel cells 10 among the plurality of fuel cells 10 from degrading quickly as compared with the other fuel cells 10.

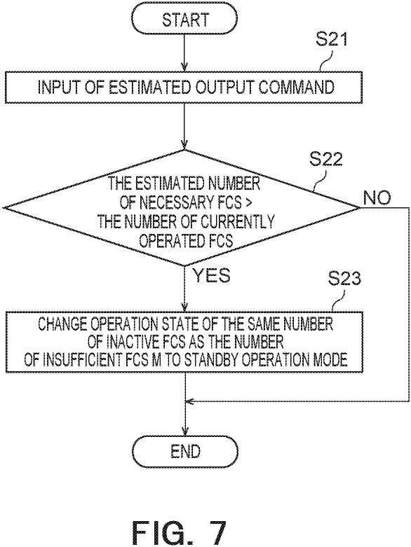

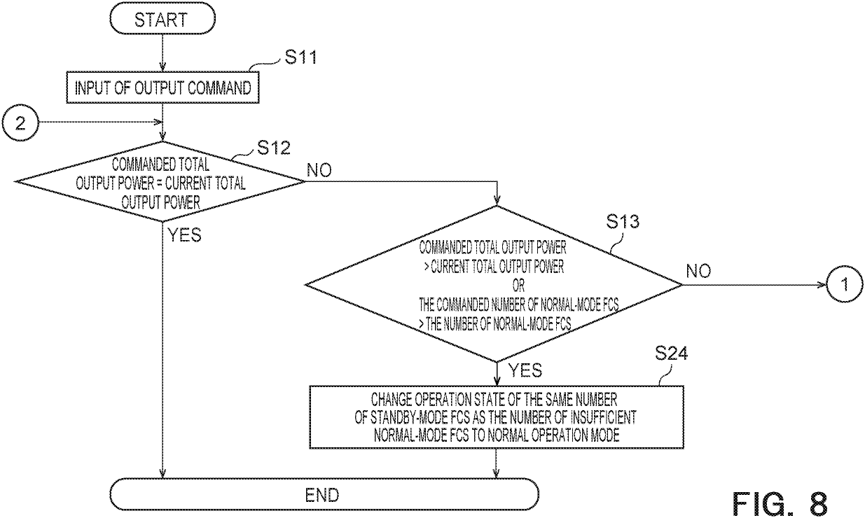

A control method of the fuel cell system 1 in the second embodiment is described with reference to FIGS. 7 and 8. A process shown in FIG. 7 is performed on a regular basis independently of a process shown in FIG. 8.

As shown in FIG. 7, an estimated output command is inputted from the operation device 30 to the estimated command receiver 25 on a regular basis (e.g., every 20 minutes) (step S21). As described above, the estimated output command shows a total output power which is expected to be generated by the fuel cell system 1 in the future (e.g., between 20 minutes and 40 minutes later than the present time).

When the estimated output command is inputted to the estimated command receiver 25, the second determiner 26 calculates the number of fuel cells which are required to output the estimated total output power (estimated number of necessary fuel cells). Then, the second determiner 26 compares the calculation result (i.e., the estimated number of necessary fuel cells) and the number of currently operated fuel cells (step S22). In step S22, when the estimated number of necessary fuel cells is greater than the number of currently operated fuel cells (YES in step S22), the second determiner 26 calculates the number of insufficient fuel cells M from the estimated number of necessary fuel cells and the number of currently operated fuel cells. Then, the second determiner 26 inputs the number of insufficient fuel cells M obtained by the calculation to the operation state manager 24.

When the number of insufficient fuel cells M is inputted from the second determiner 26, the operation state manager 24 selects the same number of inactive fuel cells 10, which have been activated/deactivated the least number of times, as the number of insufficient fuel cells M, and changes the operation state of the selected fuel cells to the standby operation mode (step S23). As a result, these fuel cells 10 are activated and operated in the standby operation mode. In addition, in step S23, the operation state manager 24 transmits, to the information collector 21, information about the operation state of each fuel cell 10.

In step S22, when the estimated number of necessary fuel cells is less than the number of currently operated fuel cells (NO in step S22), there is no input from the second determiner 26 to the operation state manager 24. As a result, activation of a inactive fuel cell 10 is not performed in response to the input of the estimated output command.

After the process shown in FIG. 7, when the command receiver 22 acquires an output command form the operation device 30 (step S11), as shown in FIG. 8, the first determiner 23 performs the judgment of step S12, similarly to the case shown in FIG. 4. In the case of NO in step S12, the first determiner 23 performs the judgment of step S13. In the case of YES in step S13, the first determiner 23 calculates the number of fuel cells which are required to output the commanded total output power (i.e., the commanded number of normal-mode fuel cells).

Then, the first determiner 23 calculates the shortage of normal-mode fuel cells for outputting the commanded total output power (i.e., the number of insufficient normal-mode fuel cells), and inputs the calculation result to the operation state manager 24. Then, the operation state manager 24 selects the same number of standby-mode fuel cells 10 as the number of insufficient normal-mode fuel cells, and changes the operation state of the selected fuel cells 10 to the normal operation mode (step S24). As a result, the operation state of the same number of fuel cells 10 as the number of insufficient normal-mode fuel cells is changed from the standby operation mode to the normal operation mode.

The aforementioned embodiments can be variously modified. For example, in the aforementioned embodiments, the commanded total output power is any of 0 kW, 50 kW, 100 kW, 150 kW, 200 kW, 250 kW and 300 kW. However, the disclosure is not limited thereto. The commanded total output power may be any value such as 42 kW, 58 kW, 142 kW, etc. In this case, a normal-mode fuel cell 10 may be operated to output any amount of power, as long as the fuel cell 10 is operated to output power which is 40% to 60% of its maximum output power. For example, when the maximum output power of each fuel cell 10 is 100 kW and a commanded total output power is 42 kW, one normal-mode fuel cell 10 may outputs power which is 42% of the maximum output power. In addition, when the maximum output power of each fuel cell is 100 kW and a commanded total output power is 142 kW, two fuel cells 10 may be operated in normal operation mode to output power which is 50% of the maximum output power, and one fuel cell 10 may be operated in normal operation mode to output power which is 42% of the maximum output power.

As described above, the fuel cell system 1 according to the first and second embodiments comprises a plurality of fuel cells 10, and a control device 20 that controls an operation state of each fuel cell 10. Each fuel cell 10 is capable of being operated in multiple operation modes including a normal operation mode in which the fuel cell 10 is operated to output power with a power generation efficiency equal to or greater than a first power generation efficiency, and a standby operation mode in which the fuel cell 10 is operated to output power with a power generation efficiency equal to or less than a second power generation efficiency which is lower than the first power generation efficiency. The control device 20 has a command receiver 22, a first determiner 23, and an operation state manager 24. The command receiver 22 acquires an output command showing a total output power which should be generated by the fuel cell system 1. The first determiner 23 determines the number of fuel cells 10 which should be operated in the normal operation mode, based on the total output power shown by the output command. The operation state manager 24 determines the operation state of each fuel cell 10, based on the number of fuel cells 10 determined by the first determiner 23. When the total output power shown by the output command is lower than a total output power which is being generated by the fuel cell system 1, or when the number of fuel cells 10 determined by the first determiner 23 is less than the number of fuel cells 10 which are being operated in the normal operation mode, the operation state manager 24 changes the operation state of at least one of the fuel cells 10 operated in the normal operation mode to the standby operation mode. On the other hand, when the total output power shown by the output command is greater than a total output power which is being generated by the fuel cell system 1, or when the number of fuel cells 10 determined by the first determiner 23 is greater than the number of fuel cells 10 which are being operated in the normal operation mode, the operation state manager 24 changes the operation state of at least one of the fuel cells 10 operated in the standby operation mode to the normal operation mode.

Such a fuel cell system 1 as a whole can achieve a power generation efficiency which is equal to or greater than a predetermined power generation efficiency. When the number of fuel cells 10 which are being operated in the normal operation mode is greater than the number of fuel cells 10 which are required to output the total output power shown by the output command, the fuel cell system 1 changes the operation state of a surplus normal-mode fuel cell 10 to the standby operation mode, instead of immediately deactivating the surplus normal-mode fuel cell 10. Alternatively, when the number of fuel cells 10 which are being operated in the normal operation mode is less than the number of fuel cells 10 which are required to output the total output power shown by the output command, the fuel cell system 1 changes the operation state of a fuel cell 10 operated in the standby operation mode to the normal operation mode. By controlling the plurality of fuel cells 10 as described above, it is possible to reduce occasion of activating a inactive fuel cell 10, when a total output power of the fuel cell system 1 is increased. This can improve responsiveness of an output power of the fuel cell system 1.

In the fuel cell system 1 according to the first and second embodiments, the control device 20 further has an information collector 21 that acquires information about the number of times each fuel cell 10 has been activated. The operation state manager 24 selects, based on the information acquired by the information collector, a fuel cell 10 which has been activated the least number of times among the fuel cells 10 which are being operated in the normal operation mode, and changes the operation state of the selected fuel cell 10 to the standby operation mode. It is highly probable that the fuel cell 10 operated in the standby operation mode is deactivated later. Thus, by changing the operation state of the normal-mode fuel cell 10 which has been activated the least number of times to the standby operation mode, it is possible to hinder the plurality of fuel cells 10 from being activated unevenly. Thus, it is possible to hinder a certain fuel cell 10 among the plurality of fuel cells 10 from degrading quickly as compared with the other fuel cells 10.

In the fuel cell system 1 according to the first and second embodiments, the control device 20 further has an information collector 21 that acquires information about the number of fuel cells 10 which are being operated in the standby operation mode, and the number of times each fuel cell 10 has been activated. When the information acquired by the information collector 21 shows the number of fuel cells 10 which are being operated in the standby operation mode is greater than the predetermined number N, the operation state manager 24 selects, from the fuel cells 10 which are being operated in the standby operation mode, a fuel cell 10 which has been activated the least number of times based on the information acquired by the information collector 21, and determines to deactivate the selected fuel cell. Thus, it is possible to hinder the plurality of fuel cells 10 from being activated unevenly. As a result, it is possible to hinder a certain fuel cell 10 among the plurality of fuel cells 10 from degrading quickly as compared with the other fuel cells 10.

In the fuel cell system 1 according to the first and second embodiments, the control device 20 further has an information collector 21 that acquires information about the number of times each fuel cell 10 has been activated. When a total output power shown by an output command is greater than a total output power which is being generated by the fuel cell system 1, or when the number of fuel cells 10 determined by the first determiner 23 is greater than the number of fuel cells 10 which are being operated in the normal operation mode, the operation state manager 24 selects, from the inactive fuel cells 10, a fuel cell 10 which has been activated the least number of times based on the information acquired by the information collector 21, and determines to activate the selected fuel cell. Thus, it is possible to hinder the plurality of fuel cells 10 from being activated unevenly. As a result, it is possible to hinder a certain fuel cell 10 among the plurality of fuel cells 10 from degrading quickly as compared with the other fuel cells 10.

In the fuel cell system 1 according to the second embodiment, the information collector 21 acquires information about the number of fuel cells 10 which are being operated in the standby operation mode. When the number of fuel cells 10 acquired by the information collector 21 is less than the predetermined number (specifically, the difference between the estimated number of necessary fuel cells and the number of normal-mode fuel cells at the time point when the estimated output command is inputted), the operation state manager 24 selects, from the inactive fuel cells 10, a fuel cell 10 which has been activated the least number of times based on the information acquired by the information collector 21, and determines to operate the selected fuel cell in the standby operation mode. This can more effectively reduce occasion of activating a inactive fuel cell 10, when a total output power of the fuel cell system 1 is increased. As a result, responsiveness of output power of the fuel cell system 1 can be improved. In addition, it is possible to hinder the plurality of fuel cells 10 from being activated unevenly. As a result, it is possible to hinder a certain fuel cell 10 among the plurality of fuel cells 10 from degrading quickly as compared with the other fuel cells 10.

In the fuel cell system 1 according to the first and second embodiments, when operated in the normal operation mode, the fuel cell 10 outputs power which is 40% to 60% of a maximum output power of this fuel cell 10. This can effectively improve a power generation efficiency of the fuel cell system 1 as a whole.

In the fuel cell system 1 according to the first and second embodiments, when operated in the normal operation mode, the fuel cell 10 outputs power with a maximum power generation efficiency of this fuel cell 10. This can further effectively improve a power generation efficiency of the fuel cell system 1 as a whole.

In the fuel cell system 1 according to the first and second embodiments, when operated in the standby operation mode, the fuel cell 10 outputs power which is 5% to 15% of the maximum output power of this fuel cell 10.

The control method according to the first and second embodiments is a control method of a fuel cell system 1 including a plurality of fuel cells 10 each of which is capable of being operated in multiple operation modes including a normal operation mode in which the fuel cell 10 is operated to output power with a high power generation efficiency equal to or greater than a first power generation efficiency, and a standby operation mode in which the fuel cell 10 is operated to output power with a low power generation efficiency equal to or less than a second power generation efficiency which is lower than the first power generation efficiency. This control method comprises a step of acquiring output command, a step of determining the number of normal-mode fuel cells, and a step of determining operation state. In the step of acquiring output command, an output command showing a total output power which should be generated by the fuel cell system 1 is acquired. In the step of determining the number of normal-mode fuel cells, the number of fuel cells 10 which should be operated in the normal operation mode is determined, based on the total output power shown by the output command. In the step of determining operation state, the operation state of each fuel cell 10 is determined, based on the number of fuel cells 10 determined in the step of determining the number of normal-mode fuel cells. Specifically, in the step of determining operation state, when the total output power shown by the output command is lower than a total output power which is being generated by the fuel cell system 1, or when the number of fuel cells 10 determined in the step of determining the number of normal-mode fuel cells is less than the number of fuel cells 10 which are being operated in the normal operation mode, the operation state of at least one of the fuel cells 10 which are being operated in the normal operation mode is changed to the standby operation mode. On the other hand, in the step of determining operation state, when the total output power shown by the output command is greater than a total output power which is being generated by the fuel cell system 1, or when the number of fuel cells 10 determined in the step of determining the number of normal-mode fuel cells is greater than the number of fuel cells 10 which are being operated in the normal operation mode, the operation mode of at least one of the fuel cells 10 which are being operated in the standby operation mode is changed to the normal operation mode.

Such a control method of a fuel cell system 1 as a whole can achieve a power generation efficiency which is equal to or more than a predetermined power generation efficiency. Furthermore, in this method, when the number of fuel cells 10 which are being operated in the normal operation mode is greater than the number of fuel cells 10 which are required to output the total output power shown by the output command, the operation state of a normal-mode fuel cell 10 which is surplus to the requirement is changed to the standby operation state, instead of being immediately changed to the inactive state. Alternatively, in this method, when the number of fuel cells 10 which are being operated in the normal operation mode is less than the number of fuel cells 10 which are required to output the total output power shown by the output command, the operation state of a fuel cell 10 which is being operated in the standby operation mode is changed to the normal operation mode. Such control of the plurality of fuel cells 10 can reduce occasion of activating a inactive fuel cell 10, when a total output power of the fuel cell system 1 is increased. As a result, responsiveness of an output power of the fuel cell system 1 can be improved.

This embodiment can improve responsiveness of an output power of the fuel cell system 1.

While some embodiments and their modification examples have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fail within the scope and spirit of the invention. It goes without saying that these embodiments and the modification examples can be suitably combined partially within the scope of the present invention.

What is claimed is:

1. A fuel cell system comprising:
a plurality of fuel cells; and
a control device that controls an operation state of each fuel cell;
wherein:
each fuel cell is capable of being operated in multiple operation modes including a normal operation mode in which the fuel cell is operated to output power with a power generation efficiency equal to or greater than a first power generation efficiency, and a standby operation mode in which the fuel cell is operated to output power with a power generation efficiency equal to or less than a second power generation efficiency which is lower than the first power generation efficiency;
the control device has:
a command receiver that acquires an output command showing a total output power which should be generated by the fuel cell system;
a first determiner that determines the number of fuel cells which should be operated in the normal operation mode, based on the total output power shown by the output command; and
an operation state manager that determines the operation state of each fuel cell, based on the number of fuel cells determined by the first determiner;
when the total output power shown by the output command is lower than a total output power which is being generated by the fuel cell system, or when the number of fuel cells determined by the first determiner is less than the number of fuel cells which are being operated in the normal operation mode, the operation state manager changes the operation state of at least one of the fuel cells which are being operated in the normal operation mode to the standby operation mode; and
when the total output power shown by the output command is greater than a total output power which is being generated by the fuel cell system, or when the number of fuel cells determined by the first determiner is greater than the number of fuel cells which are being operated in the normal operation mode, the operation state manager changes the operation state of at least one of the fuel cells which are being operated in the standby operation mode to the normal operation mode.

2. The fuel cell system according to claim 1, wherein:
the control device further has an information collector that acquires information about the number of times each fuel cell has been activated; and
the operation state manager selects, from the fuel cells which are being operated in the normal operation mode, a fuel cell which has been activated the least number of times based on the information acquired by the information collector, and changes the operation state of the selected fuel cell to the standby operation mode.

3. The fuel cell system according to claim 1, wherein:
the control device further has the information collector that acquires information about the number of fuel cells which are being operated in the standby operation mode and the number of times each fuel cell has been activated; and
when the number of fuel cells which are being operated in the standby operation mode, which is acquired by the information collector, is greater than the predetermined number, the operation state manager selects, from the fuel cells which are being operated in the standby operation mode, a fuel cell which has been activated the least number of times based on the information acquired by the information collector and determines to deactivate the selected fuel cell.

4. The fuel cell system according to claim 1, wherein:
the control device further has the information collector that acquires information about the number of times each fuel cell has been activated; and
when the total output power shown by the output command is greater than a total output power which is being generated by the fuel cell system, or when the number of fuel cells determined by the first determiner is greater than the number of fuel cells which are being operated in the normal operation mode, the operation state manager selects, from fuel cells which are being in inactive state, a fuel cell which has been activated the least number of times based on the information acquired by the information collector and determines to operate the selected fuel cell in the normal operation mode.

5. The fuel cell system according to claim 4, wherein:
the information collector acquires information about the number of fuel cells which are being operated in the standby operation mode; and
when the number of fuel cells acquired by the information collector is less than the predetermined number, the operation state manager selects, from fuel cells which are being in inactive state, a fuel cell which has been activated the least number of times based on the information acquired by the information collector and determines to operate the selected fuel cell in the standby operation mode.

6. The fuel cell system according to claim 1, wherein
when operated in the normal operation mode, the fuel cell outputs power which is 40% to 60% of a maximum output power of this fuel cell.

7. The fuel cell system according to claim 1, wherein
when operated in the normal operation mode, the fuel cell outputs power with a maximum power generation efficiency of this fuel cell.

8. The fuel cell system according claim 1, wherein
when operated in the standby operation mode, the fuel cell outputs power which is 5% to 15% of a maximum output power of this fuel cell.

9. A control method of a fuel cell system including a plurality of fuel cells each of which is capable of being operated in multiple operation modes including a normal operation mode in which the fuel cell is operated to output power with a high power generation efficiency equal to or greater than a first power generation efficiency, and a standby operation mode in which the fuel cell is operated to output power with a low power generation efficiency equal to or less than a second power generation efficiency which is lower than the first power generation efficiency, the control method comprising:
a step of acquiring output command that acquires an output command showing a total output power which should be generated by the fuel cell system;
a step of determining the number of normal-mode fuel cells that determines the number of fuel cells which should be operated in the normal operation mode, based on the total output power shown by the output command; and
a step of determining operation state that determines an operation state of each fuel cell, based on the number of fuel cells determined in the step of determining the number of normal-mode fuel cells;
wherein:
in the step of determining operation state, when the total output power shown by the output command is lower than a total output power which is being generated by the fuel cell system, or when the number of fuel cells determined in the step of determining the number of normal-mode fuel cells is less than the number of fuel cells which are being operated in the normal operation mode, the operation state of at least one of the fuel cells which are being operated in the normal operation mode is changed to the standby operation mode; and
in the step of determining operation state, when the total output power shown by the output command is greater than a total output power which is being generated by the fuel cell system, or when the number of fuel cells determined in the step of determining the number of normal-mode fuel cells is greater than the number of fuel cells which are being operated in the normal operation mode, the operation state of at least one of the fuel cells which are being operated in the standby operation mode is changed to the normal operation mode.
